(19) United States
(12) Patent Application Publication
(10) Pub. No.: US 2004/0137324 A1
(43) Pub. Date: Jul. 15, 2004

(54) Electrolyte for nanaqueous battery, method for producing the same, and electrolytic solution for nonaqueous battery

(76) Inventors: Masaharu Itaya, Nishinomiya-city (JP); Masahide Miyake, Kobe-city (JP); Masahisa Fujimoto, Kobe-city (JP); Hideyuki Koga, Kobe-city (JP); Kazunori Donoue, Kobe-city (JP)

Correspondence Address: KUBOVCIK & KUBOVCIK, SUITE 710, 900 17TH STREET NW, WASHINGTON, DC, 20006

(21) Appl. No.: 10/743,746

(22) Filed: Dec. 24, 2003

(30) Foreign Application Priority Data
Dec. 27, 2002 (JP) 2002-381184
Feb. 28, 2003 (JP) 2003-53549

(51) Int. Cl. H01M 10/40

(52) U.S. Cl. 429/188; 429/330; 429/338

(57) ABSTRACT

An electrolyte for a nonaqueous battery according to the present invention consists essentially of magnesium bistrifluoromethanesulfonimide. An electrolytic solution for a nonaqueous battery according to the present invention includes the magnesium bistrifluoromethanesulfonimide, and an organic solvent such as a cyclic carbonate, a chain carbonate, a cyclic ether and a chain ether or an ordinary temperature molten salt having a melting point of 60° C. or less in which the magnesium bistrifluoromethanesulfonimide is dissolved.

### BACKGROUND OF THE INVENTION

1. Field of the Invention

The present invention relates to an electrolyte which is useful for a nonaqueous battery such as a magnesium ion battery, a method for producing the electrolyte and an electrolytic solution using the electrolyte.

2. Description of the Related Art

Lithium ion batteries having high energy density have been put to practical use. Attentions have been focused on magnesium and calcium as an active material having high energy density the same as that of lithium.

However, magnesium salts and calcium salts soluble in an organic solvent are few, and as for the magnesium salts, magnesium organohaloaluminate is only examined (Nature, 407, 724(2000), D. Aurbach, Z. Lu, A. Schechter, Y. Gofer, H. Gizbar, R. Turgeman, T. Cohen, M. Moshkovich and E. Levl).

### SUMMARY OF THE INVENTION

It is an object of the present invention to provide an electrolyte for a nonaqueous battery which is useful for a magnesium ion battery or the like and is a magnesium salt soluble in an organic solvent, and a method for producing the electrolyte. It is further another object of the present invention to provide an electrolytic solution for a nonaqueous battery using the electrolyte.

An electrolyte for a nonaqueous battery according to the present invention consists essentially of magnesium bistrifluoromethanesulfonimide [Mg((CF₃SO₂)₂N)₂].

The present inventors found that the magnesium bistrifluoromethanesulfonimide can be dissolved in an organic solvent, and the organic solvent in which the magnesium bistrifluoromethanesulfonimide is dissolved shows sufficient conductivity of about 10⁻³S cm⁻¹ as an electrolytic solution of a battery. The present invention was accomplished based on this finding.

The electrolyte according to the present invention can be used for a nonaqueous battery such as a magnesium ion primary battery and a magnesium ion secondary battery.

An electrolytic solution for a nonaqueous battery according to the present invention includes the magnesium bistrifluoromethanesulfonimide as the electrolyte according to the present invention. Specifically, the magnesium bistrifluoromethanesulfonimide is dissolved in an organic solvent and/or a room temperature molten salt having a melting point of 60° C. or less.

Examples of organic solvents in which the electrolyte according to the invention can be dissolved include a cyclic carbonate, a chain carbonate, a cyclic ether, a chain ether, a cyclic ester and a chain ester. The organic solvents may individually be used or a mixture of two or more kinds thereof may be used.

Examples of cyclic carbonates include ethylene carbonate (EC), propylene carbonate (PC), butylene carbonate (BC), trifluoropropylene carbonate (TFPC) and fluoroethylene carbonate (FEC). Examples of chain carbonates include dimethyl carbonate (DMC), diethyl carbonate (DEC) and methyl ethyl carbonate (MEC). Examples of cyclic ethers include sulfolane (SL), tetrahydrofuran (THF) and crown ether (12-crown 4, 15-crown 5, 18-crown 6 or the like). Examples of chain ethers include dimethoxyetane (DME), ethoxymethoxy ethane (EME) and diethoxyethane (DEE). Examples of cyclic esters include γ-butyrolactone (γ-BL), valerolactone (VL) and angelica lactone (AL). Examples of chain esters include methyl formate (MF), methyl acetate (MA) and methyl propionate (MP).

Examples of room temperature molten salts having a melting point of 60° C. or less in which the electrolyte according to the present invention can be dissolved include salts made by combining a cation selected from ammonium, imidazolium, pyrazolium, triazolium, thiazolium, oxazolium, pyridinium, pyridazinium, pyrimidonium and pyrazinium, and an anion selected from BR₄⁻, PR₆⁻, RSO₃⁻, (RSO₂)₂N⁻ and (RSO₂)₃C⁻ (wherein R represents a halogen element, CF₃, C₂F₅, or an alkyl group or an aryl group having other electron-attracting groups). Specifically, examples of ammonium salts include trimethylpropyl ammonium-bis-(trifluoro methylsulfonyl) imide (TMPA-TFSI) ((CH₃)₃N⁺(C₃H₇).N⁻(SO₂CF₃)₂). Examples of imidazolium salts include 1-ethyl-3-methyl imidazolium-2,2,2-trifluoro-N-(trifluoro methylsulfonyl) acetamide ((C₆H₁₁N₂)⁺.(CF₃CO)N⁻(SO₂CF₃)). Examples of pyrazolium salts include 1,2-dimethyl-4-fluoropyrazolium-tetrafluoroborate ((C₅H₈N₂F)⁺.BF₄⁻). Examples of pyridinium salts include 1-ethyl pyridinium-2,2,2-trifluoro-N-(trifluoro methylsulfonyl) acetamide ((C₇H₁₀N)⁺.(CF₃CO)N⁻ (SO₂CF₃)).

The magnesium bistrifluoromethanesulfonimide dissolved in the organic solvent or the room temperature molten salt is not limited to particular amount. The magnesium bistrifluoromethanesulfonimide is dissolved in an amount to cause the conductivity required such as the conductivity of 10⁻³S cm⁻¹.

A method for producing an electrolyte for a nonaqueous battery according to the present invention comprises the step of reacting magnesium carbonate or magnesium hydroxide with an imide compound to produce the electrolyte for a nonaqueous battery.

When the magnesium bistrifluoromethanesulfonimide which is the electrolyte for a nonaqueous battery according to the present invention is produced, the magnesium bistrifluoromethanesulfonimide can be produced by reacting magnesium carbonate or magnesium hydroxide with trifluoromethanesulfonimide.

By using the electrolytic solution for a nonaqueous battery according to the present invention, a positive electrode made of Mg_{X}Mo₃S₄ and a negative electrode made of Mg, a magnesium ion secondary battery can be composed.

A nonaqueous electrolyte battery according to the present invention is characterized by comprising a nonaqueous electrolyte including an ether based solvent and a magnesium salt, a positive electrode including magnesium as an active material and a negative electrode including magnesium as an active material.

In the constitution, by using the ether based solvent a coating is formed on the surface of magnesium by the reaction of the magnesium with an electrolytic solution. Because magnesium ions can permeate the coating, the magnesium can be easily occluded and deposited. Accordingly, the present invention can provide a battery using magnesium which has high capacity and high safety.

The ether based solvent preferably includes a chain ether.

In addition dimethoxyethane (DME) is preferably used as the chain ether. The use of DME makes the magnesium ions permeate easily and the magnesium can easily be deposited. Accordingly, a nonaqueous electrolyte secondary battery having high capacity can be obtained.

Additionally, a chain ether such as diethoxymethane and ethoxymethoxyethane is also effective in addition to dimethoxyethane.

A cyclic ether such as tetrahydrofuran and dioxolane is also effective in addition to the chain ether.

The magnesium salt preferably includes at least one of an imide salt and a sulfonate.

Because of the additional stablity and less oxygen emission compared with magnesium perchlorate, the imide salt or the sulfonate has high safety as an electrolyte. Accordingly, a nonaqueous electrolyte battery having high safety and high capacity can be provided.

The imide salt is preferably an alkylsulfonylimide salt. The alkylsulfonylimide salt can be easily obtained due to easy of synthesis.

The alkylsulfonylimide salt is preferably magnesium bistrifluoromethanesulfonimide. When the magnesium bistrifluoromethanesulfonimide is used as an electrolyte, a battery having high conductivity, high output and high capacity can be provided. The conductivity of magnesium bistrifluoromethanesulfonimide is about 10 times as high as that of trifluoromethanesulfonate Mg (CF₃SO₃)₂.

The sulfonate is preferably an alkylsulfonate.

The alkylsulfonate is preferably magnesium trifluoromethanesulfonate. The magnesium trifluoromethanesulfonate can be easily synthesized, accordingly, a battery having high output and high capacity can be provided.

Herein, the imide salts used effectively include magnesium alkylsulfonylimide [Mg[N(CₓF₂ₓ₊₁SO₂)₂]₂ (wherein x is 1 to 8). Particularly, when x is 1 or 2, Mg[N(CₓF₂ₓ₊₁SO₂)₂]₂ can be easily synthesized.

For example, the alkylsulfonylimide salt of magnesium preferably includes at least one selected from Mg[N(CF₃SO₂)₂]₂, Mg[N(C₂F₆SO₂)₂]₂, Mg[(C₄F₉SO₂) (CF₃SO₂)N]₂, Mg[(C₆F₅SO₂) (CF₃SO₂)N]₂, Mg[(C₈F₁₇SO₂) (CF₃SO₂)N]₂, Mg[N(CF₃CH₂OSO₂)₂]₂, Mg[N(CF₃CF₂CH₂OSO₂)₂]₂ and Mg[N((CF₃)₂CHOSO₂)₂]₂.

Additionally, examples of the sulfonates include Mg(CₓF₂ₓ₊₁SO₃)₂ (wherein x is 1 to 8). Particularly, when x is 1 or 2, Mg[N(CₓF₂ₓ₊₁SO₂)₂]₂ can be easily synthesized.

Particularly, the sulfonates including magnesium trifluoromethanesulfonate [Mg(CF₃SO₃)₂] are preferable because of the high safety. Additionally, the sulfonates preferably include at least one selected from Mg(C₄F₉SO₃)₂, Mg(C₆F₁₃SO₃)₂ and Mg(C₈F₁₇SO₃)₂.

Further, Mg(CH₃SO₃)₂, Mg(C₆F₅SO₃)₂ and Mg(C₆H₅SO₃)₂ or the like have similar high safety.

Herein, the imide salt or the sulfonate may individually be used or a mixture of two or more thereof may be used. The magnesium salt is dissolved in the ether based solvent at a concentration from 0.1 to 1.5M, preferably, 0.5 to 1.5M to prepare the solution to be used.

As appeared from the results, a battery having stability and high capacity can be provided by using the solution having the concentration.

Herein, the electrolyte can be used as a solid electrolyte or an electrolytic solution including a salt as an electrolyte and an organic solvent or the like in which the salt is dissolved.

As described above, the ether type organic solvent used for a nonaqueous electrolyte (an electrolytic solution) is preferably a chain ether.

Examples of chain ethers include at least one selected from 1,2-dimethoxyetane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzil ethyl ether, diphenyl ether, dibenzyl ether, o-dimethoxybenzene, 1,2-diethoxyetane, 1,2-dibutoxyetane, diethylene glycol dimethyl ether, diethylene glycol diethyl ether, diethylene glycol dibutyl ether, dimethoxymethane, 1,1-diethoxyethane, triethylene glycol dimethyl ether and tetra ethylene glycol dimethyl ether. Also, a mixture solvent of two or more thereof is effective.

Further, the positive electrode or the negative electrode preferably includes any one of a magnesium metal, a magnesium alloy, a magnesium oxide, silicon, carbon, fluorocarbon and a transition metal sulfide.

### BRIFF DESCRIPTION OF THE DRAWINGS

FIG. 1 is a perspective view showing a test cell prepared in an example of the present invention.

FIG. 2 is a diagram showing charge characteristics of the test cell of example of the present invention.

FIG. 3 is a diagram showing charge characteristics of the test cell of comparative example.

### DESCRIPTION OF THE PREFFERED EMBODIMENTS

Hereinbelow, the present invention will be described in detail by way of examples, although the present invention is not limited to the following examples.

### EXAMPLE 1

Trifluoromethanesulfonimide ((CF₃SO₂)₂NH: hereinbelow, referred to as “HTFSI”) was dissolved in 1 liter of water to prepare a 1 mole/liter (1M) solution. Magnesium carbonate (MgCO₃) was added to the solution at 1:2 mole ratio of MgCO₃ to HTFSI while the solution was stirred. The magnesium carbonate reacted with the HTFSI as follows to form magnesium bistrifluoromethanesulfonimide, carbon dioxide and water.

MgCO₃+2HTFSI→Mg(TFSI)₂+CO₂+H₂O [Formula 1]

When magnesium hydroxide was used in place of the magnesium carbonate, the magnesium hydroxide reacted with the HTFSI as follows to form magnesium bistrifluoromethanesulfonimide and water.

Mg(OH)₂+2HTFSI→Mg(TFSI)₂+2H₂O [Formula 2]

After the present inventors confirmed that the magnesium carbonate was entirely dissolved, water and carbon dioxide were removed by depressurization by using a rotary evaporator to obtain white magnesium bistrifluoromethanesulfonimide. The magnesium bistrifluoromethanesulfonimide obtained was vacuum-dried at 220° C. for 8 hours to obtain anhydrous magnesium bistrifluoromethanesulfonimide.

The magnesium bistrifluoromethanesulfonimide obtained was added to propylene carbonate (PC), a mixture solvent (EC:DMC) of 1:1 volume ratio of ethylene carbonate (EC) to dimethyl carbonate (DMC), γ-butyrolactone (γ-BL) and butylene carbonate (BC) respectively. The present inventors confirmed that the magnesium bistrifluoromethanesulfonimide is dissolved in the solvents. Additionally, the conductivity of each solution in which 1M (1 mole/liter) of the magnesium bistrifluoromethanesulfonimide was dissolved was measured. The results were shown in Table 1. The moisture value in 1M of each solution was 100 ppm or less.

When the magnesium bistrifluoromethanesulfonimide was added to trimethylpropyl ammonium trifluoromethanesulfonimide (TMPA-TFSI) as a room temperature molten salt, the present inventors confirmed the dissolution of the magnesium bistrifluoromethanesulfonimide. Additionally, the conductivity of 0.5 M (0.5 mole/liter) of the room temperature molten salt solution was measured and the result was shown in Table 1. The conductivity shown in Table 1 was measured at 25° C.

TABLE 1

| Solvent | Conductivity (×10⁻³ Scm⁻¹) |
|---|---|
| PC | 3.31 |
| EC:DMC | 5.83 |
| γ-BL | 6.87 |
| BC | 1.34 |
| TMPA-TFSI | 2.50 |

As shown in Table 1, the conductivity of each solution was in the range of 1.34×10⁻³ to 6.87×10⁻³S cm⁻¹. The conductivities were almost equal to that (7.90×10⁻³S cm⁻¹) of a mixture solvent of 1:1 volume ratio of EC to DEC (diethyl carbonate) which was a typical electrolytic solution for a lithium ion battery and in which 1M of LiPF₆ was dissolved. Therefore, the solutions can be used as an electrolytic solution for a nonaqueous battery.

The present invention can provide an electrolyte and an electrolytic solution for a nonaqueous battery which are useful for a magnesium ion battery or the like. Additionally, an electrolyte for a nonaqueous battery as a magnesium salt which is soluble in an organic solvent or the like can be produced in a convenient process by the method for producing according to the present invention.

### EXAMPLE 2

### 1. Preparation of the Positive Electrode

A magnesium metal plate cut to a prescribed size was used as a positive electrode (a positive electrode including magnesium as an active material) which was made of a magnesium metal and was a working electrode.

### 2. Preparation of the Negative Electrode

Likewise, a magnesium metal plate cut to a prescribed size was used as a negative electrode (a negative electrode including magnesium as an active material) which was made of a magnesium metal and was a counter electrode.

On the other hand, a reference electrode made of a lithium metal plate cut to a prescribed size was prepared.

### 3. Preparation of the Electrolytic Solution

Magnesium bistrifluoromethanesulfonimide was dissolved in dimethoxyethane at a concentration of 0.5 mole/liter to obtain a nonaqueous electrolyte.

### 4. Preparation of the Test Cell

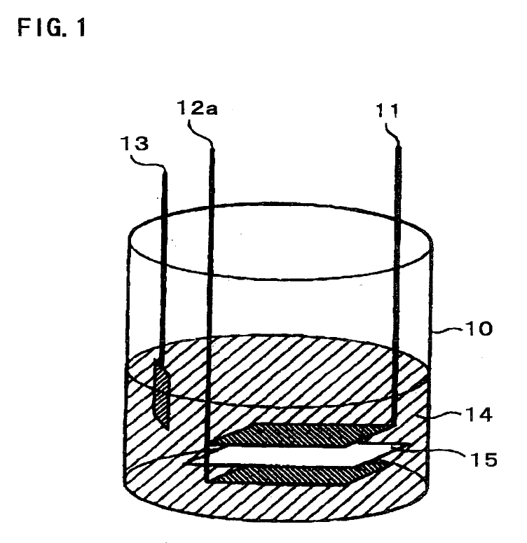

A positive electrode 12a was prepared as a working electrode by fixing a lead to the positive electrode prepared as described above. A negative electrode 11 was prepared as a counter electrode by fixing a lead to the negative electrode prepared as described above. A reference electrode 13 was prepared by fixing a lead to the reference electrode prepared as described above. The nonaqueous electrolyte 14 was injected in a test cell vessel 10 to prepare a test cell as shown in FIG. 1. Numeral 15 designates a separator.

### 5. Test

The constant current charge was performed with charging current having current density of 0.1 mA/cm² for the test cell prepared as described above for 1 hour in room temperature atmosphere.

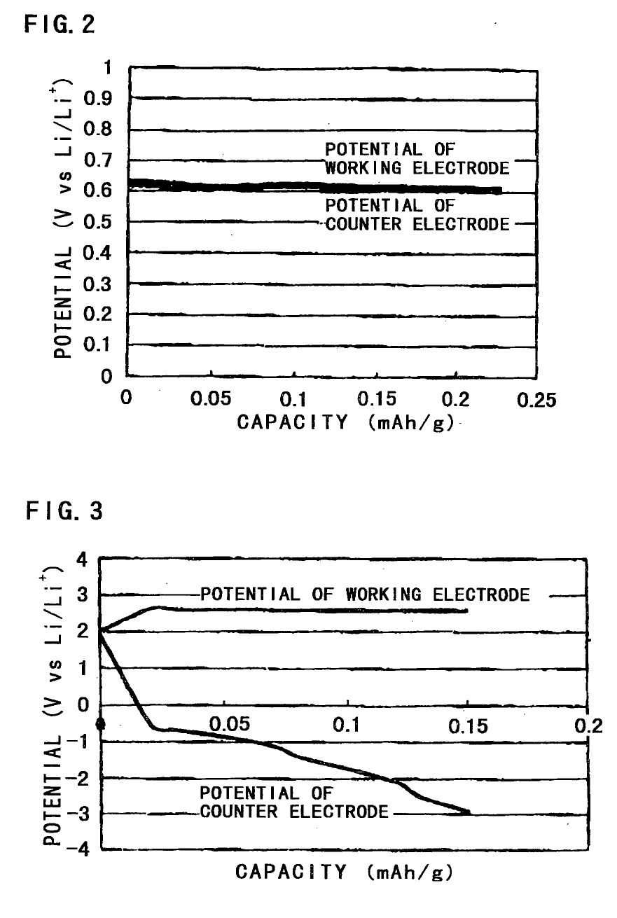

The charging characteristic was shown in FIG. 2. The charging curves showed that the dissolution of Mg occurs near 0.63 V (Li/Li⁺) on the working electrode.

On the other hand, the deposition of Mg occurred near 0.61 V (Li/Li⁺) on the counter electrode.

The result showed that the dissolution and deposition of magnesium easily occurs by using the electrolyte including dimethoxyethane.

### Comparative Example

Except for using γ-butyrolactone in place of dimethoxyethane as the solvent of the electrolytic solution, a cell was prepared in the same way as the Example 1. The cell was measured in the same way as the Example.

The result was shown in FIG. 3. The dissolution of Mg occurred near 2.7 V (Li/Li⁺) on the working electrode. On the other hand, because the deposition of Mg did not occur on the counter electrode, the potential was not constant and gradually decreased.

In this manner, the dissolution of magnesium occurred in many nonaqueous solvents, but the deposition of magnesium did not occur.

What is claimed is:

1. An electrolyte for a nonaqueous battery consisting essentially of magnesium bistrifluoromethanesulfonimide.

2. A method for producing an electrolyte for a nonaqueous battery comprising the step of reacting magnesium carbonate or magnesium hydroxide with an imide compound to produce the electrolyte for a nonaqueous battery.

3. A method for producing an electrolyte for a nonaqueous battery comprising the step of reacting magnesium carbonate or magnesium hydroxide with trifluoromethanesulfonimide to produce magnesium bistrifluoromethanesulfonimide.

4. An electrolytic solution for a nonaqueous battery comprising:
magnesium bistrifluoromethanesulfonimide; and
an organic solvent and/or a room temperature molten salt having a melting point of 60° C. or less in which the magnesium bistrifluoromethanesulfonimide is dissolved.

5. The electrolytic solution for a nonaqueous battery according to claim 4, wherein at least one kind selected from the group consisting of a cyclic carbonate, a chain carbonate, a cyclic ether, a chain ether, a cyclic ester and a chain ester is used as the organic solvent.

6. The electrolytic solution for a nonaqueous battery according to claim 4, wherein the organic solvent is at least one kind selected from the group consisting of ethylene carbonate, propylene carbonate, butylene carbonate, trifluoropropylene carbonate, fluoroethylene carbonate, dimethyl carbonate, diethyl carbonate, methyl ethyl carbonate, sulfolane, tetrahydrofuran, crown ether, dimethoxyethane, ethoxymethoxy ethane, diethoxyetane, γ-butyrolactone, valerolactone, angelica lactone, methyl formate, methyl acetate and methyl propionate.

7. The electrolytic solution for a nonaqueous battery according to claim 4, wherein an ammonium salt is used as the room temperature molten salt.

8. The electrolytic solution for a nonaqueous battery according to claim 7, wherein the ammonium salt is trimethylpropyl ammonium-bis-(trifluoromethylsulfonyl) imide.

9. A nonaqueous battery comprising:
a positive electrode;
a negative electrode; and
an electrolytic solution including magnesium bistrifluoromethanesulfonimide, and an organic solvent and/or an ordinary temperature molten salt having a melting point of 60° C. or less in which the magnesium bistrifluoromethanesulfonimide is dissolved.

10. The nonaqueous battery according to claim 9, wherein the nonaqueous battery is a magnesium ion battery.

11. A nonaqueous electrolyte battery comprising:
a nonaqueous electrolyte including an ether based solvent and a magnesium salt;
a positive electrode including magnesium as an active material; and
a negative electrode including magnesium as an active material.

12. The nonaqueous electrolyte battery according to claim 11, wherein the ether based solvent includes a chain ether.

13. The nonaqueous electrolyte battery according to claim 12, wherein the chain ether is dimethoxyethane (DME).

14. The nonaqueous electrolyte battery according to claim 11, wherein the magnesium salt includes at least one of an imide salt and a sulfonate.

15. The nonaqueous electrolyte battery according to claim 14, wherein the imide salt is an alkylsulfonylimide salt.

16. The nonaqueous electrolyte battery according to claim 15, wherein the alkylsulfonylimide salt is magnesium bistrifluoromethanesulfonimide.

17. The nonaqueous electrolyte battery according to claim 14, wherein the sulfonate is an alkylsulfonate salt.

18. The nonaqueous electrolyte battery according to claim 17, wherein the alkylsulfonate salt is magnesium trifluoromethanesulfonate [Mg (CF₃SO₃)₂].

19. The nonaqueous electrolyte battery according to claim 11, wherein the positive electrode or the negative electrode includes at least one of a magnesium metal, a magnesium alloy, a magnesium oxide, silicon, carbon, fluorocarbon and a transition metal sulfide.
